(19) United States
(12) Patent Application Publication
(10) Pub. No.: US 2001/0024690 A1
(43) Pub. Date: Sep. 27, 2001

(54) Prototype tools and models and method of making same

(76) Inventor: Scott M. Kloock, Washington, MI (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 09/854,829

(22) Filed: May 14, 2001

Related U.S. Application Data
(62) Division of application No. 09/139,302, filed on Aug. 25, 1998.

(51) Int. Cl. B05D 3/12; B05D 3/02; B28B 7/28

(52) U.S. Cl. 427/290; 427/289; 427/385.5; 249/175

(57) ABSTRACT

A tool for molding prototype parts or a model for making such a tool is constructed from a core of low cost material machined to correspond to one or more surfaces of a prototype part. A sealant covers the machined surfaces to coat and protect the underlying core. A laminating epoxy resin coating on a low density polystyrene core produces acceptable tools and models.

### BACKGROUND OF THE INVENTION

It is standard practice in the automotive industry to manufacture prototype parts long before production tooling is ready. Particularly in the case of plastic panels such as doors, quarter panels, or instrument panels, it is common to accomplish this by pouring urethane into a tool for making prototype parts. Once the urethane hardens the prototype part is a fairly good representation of the production intent for the part. It can be used for styling reviews, assembly method development, and other engineering and design functions.

This invention relates to a new construction of tooling for making prototype parts and to a new construction of models or patterns for making such tooling. A prototype part is a part having a size and shape that simulates an actual production part. That is, the prototype part normally has the same size and shape as a production part so that the prototype part at least visually functions like a production part. It may or may not mechanically function like the production version of the part. Similarly, it may or may not be made of the same material as the production part. Most commonly a prototype part has a scale of 1:1 to the production part, although there are occasions where a different scale is used.

Traditionally in the automotive industry the term model referred to a physical representation of a part. A model was the master repository of data defining a part. It was often made of wood. Casts taken from the wooden model for use in making tools were referred to as tooling aids. With the advent of computer-aided design (CAD), CAD databases have largely taken over the role of defining the master data for a part. Thus, the term “model” generally no longer connotes the function of master definition of a part, but it does still refer to a physical manifestation, made according to the CAD data, of at least one surface of a part. This change has also blurred the distinction between a model and a tooling aid. As an example in the automotive field, a model might be a block of material having on its upper surface the shape of a car's hood. The lower surface of the model may be a block a foot thick, which obviously does not simulate the interior surface of the hood. Alternatively, instead of representing just portions of a part, a model may include all surfaces of a part, in which case it is similar to a pattern. A pattern has the same overall shape as a part but, since it is used in the casting of parts or tools, a pattern generally is slightly larger than the actual desired part to allow for shrinkage during solidification.

As used herein the terms tool or tooling refer to a mold having surfaces which define a cavity in the shape of a desired part. Liquid material is poured into the mold cavity and upon curing forms a prototype part. The tool typically has two portions or halves which can be separated to remove a finished part. The mold cavity is defined by surfaces including a female portion in one half and a matching male or female portion in the other tooling half, depending on the shape of the part. Collectively the tooling, model, tooling aid and pattern will be referred to herein as a prototype accessory in that they are all used in the making of prototype parts.

The tools for making prototype parts can be made in a variety of ways. One traditional method is to use a model of the part or a tooling aid to “splash” epoxy tool halves (male and female portions separated by the intended part thickness). A more recent

method with the arrival of CAD data and computer numerically controlled (CNC) machining is to use the CAD data to create CNC machining cutter paths which machine the upper and lower tool shapes into a block or blocks (depending on the part's geometry) of wood, plastic, or high density urethane foam. The latter has a density of between 5 and 20 pounds per cubic foot. This second method has the advantages of not requiring a model to be constructed, as well as being more directly traceable to the CAD data. The disadvantage of this method is high cost due to the cost of the wood, plastic or high density foam material and the labor costs associated with the time for machining and hand finishing the tools.

Efforts have been made to reduce or eliminate these costs by making prototype accessories directly from a low cost, easily machinable material, such as low density polystyrene (about 1 to 3 pounds per cubic foot). Several problems have prevented this from being successful. The low cost and easily machinable grades of polystyrene have rough surfaces after machining due to cutter marks which may be between 0.003 and 0.080 inches deep. Also, the low density polystyrene surfaces are soft and easily damaged. Accordingly, tools made from such grades of polystyrene would yield only a limited quantity of prototype parts before normal wear and tear would render them unusable. Furthermore, such parts would have poor surface quality. Also, since polystyrene is porous, it has a tendency to adhere to the poured urethane, creating further problems with the prototype part's surface quality and causing damage to the tool.

### SUMMARY OF THE INVENTION

The present invention relates to a prototype accessory for making prototype tooling or models or patterns. A primary object of the invention is a prototype accessory which can be made quickly, accurately and inexpensively.

Another object of the invention is a prototype accessory having a significantly reduced material cost.

A further object of the invention is a prototype accessory of the type described for which CNC machining and hand finishing time and costs are greatly reduced.

Yet another object of the invention is a prototype accessory that has improved durability and produces good quality prototype parts.

Still another object of the invention is a prototype accessory which significantly reduces lead time for making prototype parts by virtue of the time savings inherent to the method.

These and other object which may become apparent in the following specification are realized by a prototype accessory having a core made of inexpensive, readily machinable material, such as low density polystyrene. At least one surface of the core is machined to form a surface corresponding to that of a prototype part. After any cutter marks are sanded out of the core, the surface is coated with a sealant such as an epoxy laminating resin The sealant improves the surface quality and forms a hard coating that protects the underlying soft core.

### BRIEF DESCRIPTION OF THE DRAWINGS

FIG. 1 is a perspective view of a thin prototype part made of urethane and produced from a low density polystyrene mold.

FIG. 2 is a perspective view of a block of foam used to make a prototype accessory prior to CNC machining.

FIG. 3 is a perspective view of the upper and lower blocks of a prototype tool after CNC machining with the part shape for the part of FIG. 1.

FIG. 4 is an enlarged side elevation view of the lower block of FIG. 3 after application of an epoxy resin coating.

FIG. 5 is a perspective view of a completed prototype tool for the part of FIG. 1.

FIG. 6 is a perspective view of a thick prototype part.

FIG. 7 is a perspective view of a lay up of the lower half of an epoxy tool used for making the part of FIG. 6.

FIG. 8 is a view similar to FIG. 7 showing the lay up of the upper half of an epoxy/fiberglass tool used for making the part of FIG. 6.

FIG. 9 is a perspective view of a completed prototype tool for the part of FIG. 6.

### DETAILED DESCRIPTION OF THE INVENTION

FIG. 1 illustrates an example of a prototype part at 10. This is a typical panel having a thin cross section. It is preferably made by pouring liquid urethane into a tool or mold and allowing the urethane to harden into the shape shown. While the current industry standard is poured urethane, it is possible that other suitable pourable materials could be used with the tooling accessories of this invention.

The tooling for making the part of FIG. 1 is made in accordance with the present invention. The starting point for making the tooling is a low cost, easily machinable material such as the block of low density polystyrene shown at 12 in FIG. 2. A density of about 1 to about 3 pounds per cubic foot would be considered low density. While low density polystyrene is a preferred material, other low cost, easily machinable materials could be used, such as low density urethane foam.

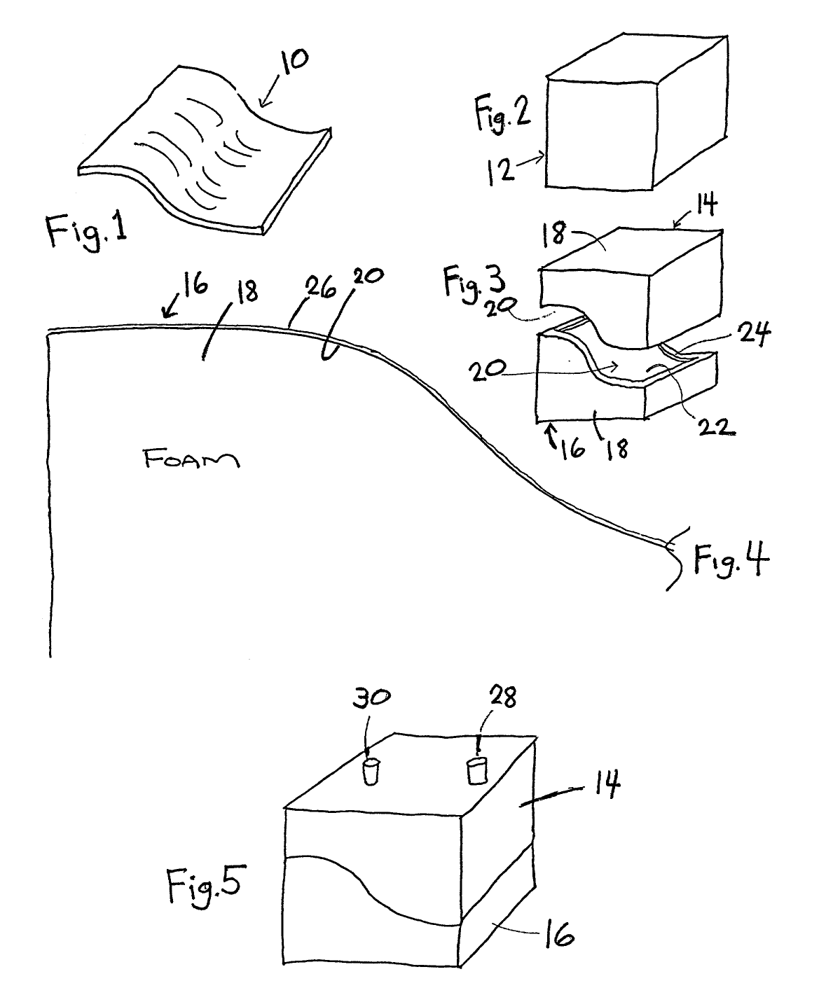

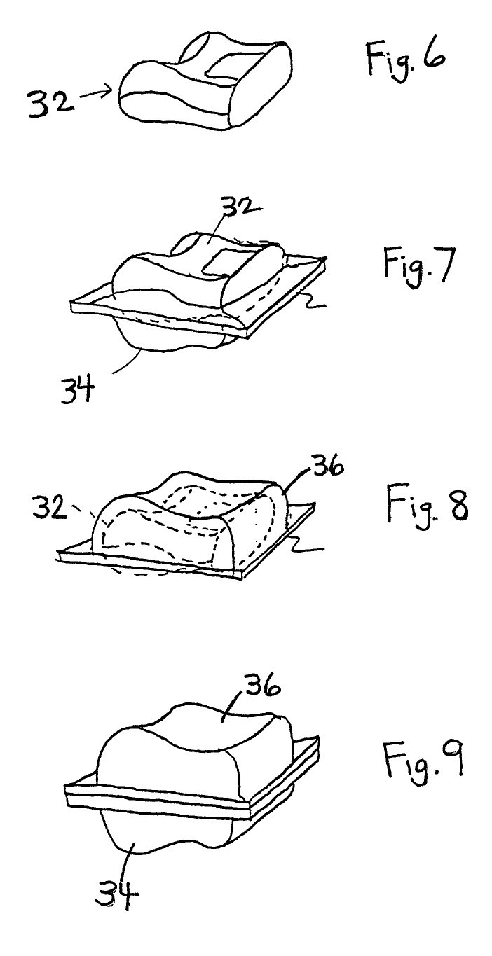

To make prototype tooling out of the blocks of low density polystyrene the CAD data for the prototype part is used to create CNC machining cutter paths which will produce the tool for the part. Using standard CNC machining practices, the upper and lower tool shapes are machined into two of the blocks 12. The resulting upper and lower tool halves are shown at 14 and 16 in FIG. 3. Each half comprises a core 18 of polystyrene with a surface corresponding to the part formed on one face of the core. In the case of the lower half 16, the surface 20 comprises a female cavity 22 surrounded by a rim 24. Depending on the desired thickness of the part, the mating surface of the upper tool half may have a male portion that fits within the rim 24 and extends into the cavity 22. Or the mating surface may simply adjoin with the rim 24 so the thickness of the part would be equal to the depth of the cavity 22. Or the mating surface of the upper tool half may itself have a female cavity, making the thickness of the part equal to the combined depth of the two cavities.

After machining the tooling halves, the machined surfaces will have cutter marks ranging in depth from 0.003 inches to about 0.080 inches. To produce the best surface quality in the prototype parts, it may be necessary to sand the cutter marks out of the tooling. Once that is done a thin coating of a protective material is applied to the machined surfaces and other areas of the tooling which may become exposed to the urethane during molding of the part. The core 18 and coating 26 are illustrated in FIG. 4. The coating is about 0.010 inches thick. Some sanding of the coating after it cures may be desirable. The coating 26 provides a hard surface that protects the core from wear, creates a smooth surface in the prototype part and permits release of finished prototype parts without damage to either the tooling or the part.

A preferred material for the protective coating 26 to be used on a low density polystyrene core is an epoxy laminating resin such as REN RP 1700-1 available from Freeman Manufacturing and Supply of Cleveland, Ohio. This epoxy resin dries to a thin, hard layer and it does not chemically attack the underlying core. Depending on the core material used, other protective coating materials could be used such as epoxies, acrylics and other plastics or adhesives, latex, silicones, cement, plasters, ceramics or polyurethane.

The completed tooling for making the prototype part of FIG. 1 is shown in FIG. 5. The upper tooling half 14 has a pour hole 28 and a vent hole 30 cut therein, both of which communicate with the cavity 22 of the lower tooling half 16. The tooling may be used according to standard procedures for prior art tooling, i.e., urethane is poured into the pour hole 28 and fills the cavity between the closed tool halves. After curing the tool halves are separated and the completed prototype part is removed from the tool.

FIGS. 6-9 illustrate an alternate embodiment of the invention wherein a tooling accessory for making thick section prototype parts is shown. Such parts may be made of urethane foam, for example, to prototype items such as automotive seat cushions. Curing urethane foam into a thick section part requires elevated temperatures for which the polystyrene tool described above is not suitable. A lay-up of epoxy and fillers laid over a model of the desired part can be used. The present invention can be used to quickly make a low-cost model for use in the lay up process for forming a high temperature tool. The steps for this process are as follows.

Using the CAD data for the prototype part, create CNC machining cutter paths that will create a model of the part to be prototyped. Using standard machining practices, CNC machine the part shape into a block (or blocks, depending on the geometry) of low density polystyrene. An example of the resulting model is shown at 32 in FIG. 6. Next, sand the cutter marks out of the polystyrene surfaces. Apply a thin coat of the epoxy laminating resin to the machined surfaces and other areas of the prototype model which may be exposed to the epoxy of the tool. Sand as necessary. This completes the model.

At this point the model is typically placed in a wooden frame for “splashing” a tool off the model. Use a combination of epoxy and fiberglass fillers to lay-up an epoxy prototype tool off of the model. This is shown in FIGS. 7 and 8 where the lower half 34 of the tool is laid up about the model 32 in FIG. 7 and the upper half 36 of the tool is separately laid up about the model 32 in FIG. 8. The completed epoxy/fiberglass tool is shown in FIG. 9. It is used per standard procedures to form prototype parts.

While a preferred form of the invention has been shown and described, it will be realized that alterations and modifications may be made thereto without departing from the scope of the following claims. For example, a pattern or tooling aid could be made by a procedure similar to that shown in FIG. 6 to make polystyrene patterns for the casting of aluminum, steel or iron tools.

What is claimed is:

1. A prototype accessory for use in making a prototype part, comprising a core of machinable material defining at least one surface having a shape corresponding to that of the prototype part, and a coating formed on said surface to protect the underlying core.

2. The prototype accessory of claim 1 wherein the core comprises at least one tool portion having a cavity therein defining said surface.

3. The prototype accessory of claim 1 wherein the core comprises a model.

4. The prototype accessory of claim 1 wherein the core is made of low density polystyrene.

5. The prototype accessory of claim 4 wherein the coating is an epoxy laminating resin.

6. The prototype accessory of claim 1 wherein the coating is an epoxy laminating resin.

7. A method of making a prototype accessory for a prototype part, comprising the steps of forming at least one surface corresponding to the prototype part in a core of machinable material, applying a sealant to said surface, and curing the sealant to form a coating for protecting the underlying core.

8. The method of claim 7 wherein the forming step comprises cutting the surface into the core.

9. The method of claim 7 further comprising the step of sanding said surface after forming it and prior to applying the sealant.

10. The method of claim 9 further comprising the step of sanding the coating.

11. The method of claim 7 wherein during the forming step all of the surfaces corresponding to the prototype part are formed in the core to create a model of the prototype part.
